(19) United States
(12) Patent Application Publication
(10) Pub. No.: US 2026/0182633 A1
(43) Pub. Date: Jul. 2, 2026

(54) ATOMIZER AND ELECTRONIC ATOMIZATION DEVICE

(71) Applicant: SHENZHEN FIRST UNION TECHNOLOGY CO., LTD., Shenzhen, Guangdong (CN)

(72) Inventors: Rui HONG, Shenzhen, Guangdong (CN); Ruilong HU, Shenzhen, Guangdong (CN); Zhiyong CHEN, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/866,186

(22) PCT Filed: May 16, 2023
(86) PCT No.: PCT/CN2023/094566

§ 371 Date: Nov. 15, 2024

(30) Foreign Application Priority Data
May 17, 2022 (CN) 202210541793.2

(51) Int. Cl. A24F 40/42; A24F 40/10; A24F 40/44; A24F 40/465; A24F 40/48; H05B 6/10

(52) U.S. Cl. CPC A24F 40/42; A24F 40/10; A24F 40/44; A24F 40/465; A24F 40/48; H05B 6/108

(57) ABSTRACT

An atomizer and an electronic atomization device are provided. The atomizer includes a housing assembly, in which a liquid storage chamber for storing a liquid substrate is arranged. The housing assembly includes a first part and a second part longitudinally arranged. An air outlet is formed on an end of the first part. At least part of the liquid storage chamber is defined by the first part. The second part longitudinally extends from an end of the first part away from the air outlet. A radial size of the second part is reduced relative to that of the first part. The atomize further includes a susceptor accommodated in the second part and configured to be penetrated by a variable magnetic field to generate heat, for heating the liquid substrate from the liquid storage chamber to generate an aerosol; and an airflow channel for guiding the aerosol to the air outlet.

### CROSS-REFERENCE TO RELATED APPLICATIONS

This application claims priority to Chinese Patent Application No. 202210541793.2, filed with China National Intellectual Property Administration on May 17, 2022 and entitled “ATOMIZER AND ELECTRONIC ATOMIZATION DEVICE”, which is incorporated herein by reference in its entirety.

### TECHNICAL FIELD

This application relates to the field of electronic atomization technologies, and in particular, to an atomizer and an electronic atomization device.

### BACKGROUND

An electronic atomization device is an electronic product that generates an aerosol by atomizing a liquid substrate for a user to inhale, which generally includes two parts: an atomizer and a power supply assembly. The liquid substrate is stored inside the atomizer, and an atomization core for atomizing the liquid substrate is arranged therein. The power supply assembly includes a battery and a circuit board.

In the process of implementing this application, the inventor found that a relatively large spacing exists between a susceptor and a magnetic field generator in an existing atomizer, and atomization efficiency is low, which affects smoking experience of a user.

### SUMMARY

This application provides an atomizer and an electronic atomization device, to resolve a problem of a relatively large spacing existing between a susceptor and a magnetic field generator in an existing atomizer.

An aspect of this application provides an atomizer, including:
a housing assembly, where a liquid storage chamber for storing a liquid substrate is arranged in the housing assembly;
the housing assembly includes a first part and a second part which are longitudinally arranged, an air outlet is formed on an end of the first part, at least part of the liquid storage chamber is defined by the first part, the second part longitudinally extends from an end of the first part away from the air outlet, and a radial size of the second part is reduced relative to that of the first part;
a susceptor, accommodated in the second part and configured to be penetrated by a variable magnetic field to generate heat, so as to heat the liquid substrate from the liquid storage chamber to generate an aerosol; and
an airflow channel, configured to guide the aerosol to the air outlet.

Another aspect of this application further provides an electronic atomization device, including the atomizer and a power supply assembly detachably connected to the atomizer. The power supply assembly includes:
a first receiving portion, configured to receive at least part of the second part; and
a magnetic field generator, configured to generate a variable magnetic field under an alternating current, where the magnetic field generator is arranged close to the first receiving portion.

In the atomizer, the susceptor is accommodated in the second part having a smaller radial size, so that the coupling distance between the susceptor and a magnetic field generator is reduced and the heating efficiency of the atomizer is improved.

### BRIEF DESCRIPTION OF THE DRAWINGS

One or more embodiments are exemplarily described with reference to the corresponding figures in the accompanying drawings, and the exemplary descriptions do not constitute a limitation on the embodiments. Elements in the accompanying drawings that have the same reference numeral are represented as similar elements, and unless otherwise particularly stated, the figures in the accompanying drawings are not drawn to scale.

FIG. 1 is a schematic diagram of an electronic atomization device according to an implementation of this application.

FIG. 2 is a schematic exploded view of an electronic atomization device according to an implementation of this application.

FIG. 3 is a schematic diagram of an atomizer according to an implementation of this application.

FIG. 4 is a schematic cross-sectional view of an atomizer according to an implementation of this application.

FIG. 5 is a schematic diagram of an upper support according to an implementation of this application.

FIG. 6 is a schematic exploded view of an atomization core according to an implementation of this application.

FIG. 7 is a schematic diagram of a bottom base according to an implementation of this application.

FIG. 8 is a schematic cross-sectional view of a bottom base according to an implementation of this application.

FIG. 9 is a schematic cross-sectional view of a power supply assembly according to an implementation of this application.

FIG. 10 is a schematic diagram of a lower housing according to an implementation of this application.

FIG. 11 is a schematic diagram of a lower support according to an implementation of this application.

FIG. 12 is a schematic diagram of a base according to an implementation of this application. FIG. 13 is a schematic diagram of a magnetic field generator according to an implementation of this application.

FIG. 14 is a schematic cross-sectional view of a magnetic field generator according to an implementation of this application.

### DETAILED DESCRIPTION

For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. A term “and/or” used in this specification includes any or all combinations of one or more related listed items.

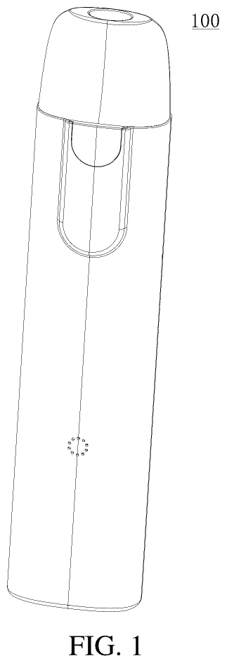

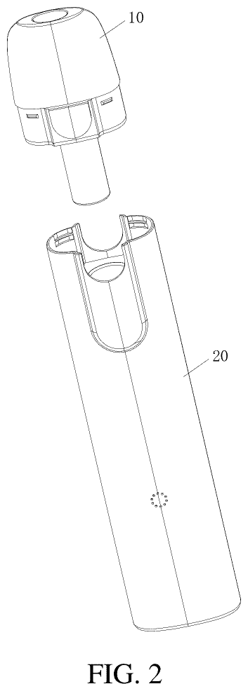

As shown in FIG. 1 and FIG. 2, an electronic atomization device 100 includes an atomizer 10 and a power supply assembly 20.

The atomizer 10 is detachably or removably connected to the power supply assembly 20, including but not limited to a snap fit, a magnetic connection, and a threaded connection.

In a preferred implementation, a bump is arranged on an outer surface of the atomizer 10. A groove is provided on an inner surface of the power supply assembly 20. The snap fit of the atomizer 10 and the power supply assembly 20 is implemented through engagement of the bump and the groove.

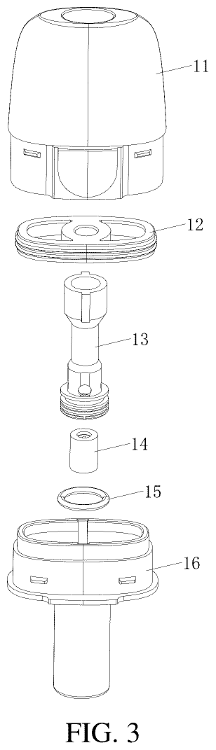

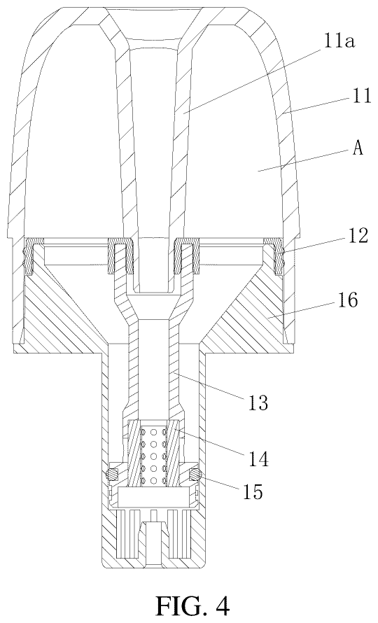

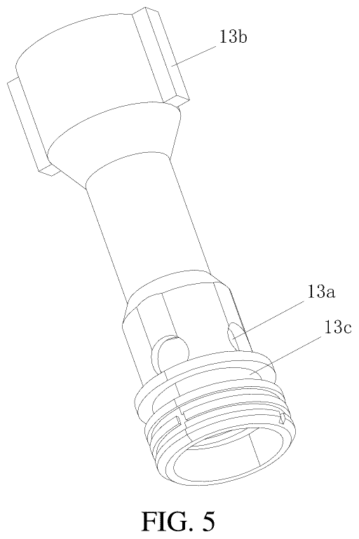

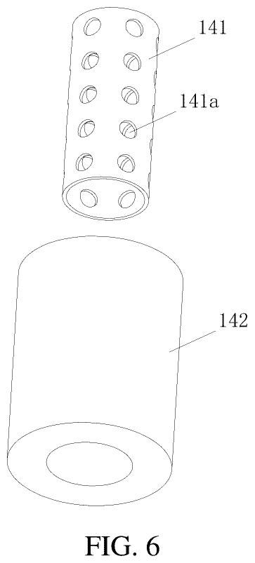

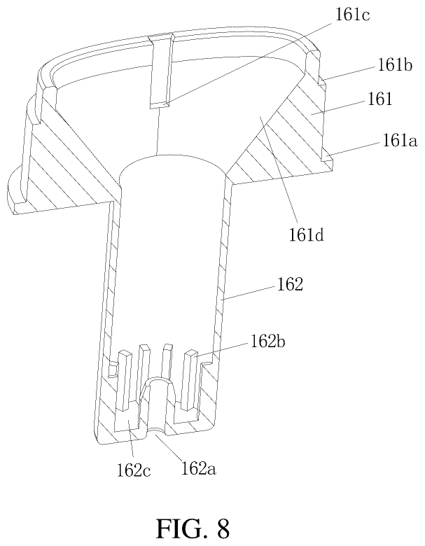

As shown in FIG. 3 to FIG. 8, the atomizer 10 includes an upper housing 11, a seal member 12, an upper support 13, an atomization core 14, a seal member 15, and a bottom base 16.

The upper housing 11 has a suction nozzle end and an open end. An air outlet is provided on the suction nozzle end, and an atomized aerosol may be inhaled by a user through the air outlet. An integrally formed transmission tube 11a is further arranged in the upper housing 11. An inner surface of the transmission tube 11a defines a part of an airflow channel. An upper end of the transmission tube 11a is in communication with the air outlet, and a lower end thereof is connected to the upper support 13. In another example, it is also feasible that the transmission tube 11a is formed by a single hollow tube.

A liquid storage chamber A is jointly defined by an inner surface of the upper housing 11 and an inner surface of the bottom base 16. The liquid storage chamber A is configured to store a liquid substrate that may generate an aerosol. It may be learned from the figures that a part of the liquid storage chamber A extends into a second connection portion 162 of the bottom base 16 and surrounds a susceptor 141.

The liquid substrate preferably includes a tobacco-containing material. The tobacco-containing material includes a volatile tobacco aroma compound released from the liquid substrate when being heated. Alternatively or additionally, the liquid substrate may include a non-tobacco material. The liquid substrate may include water, ethanol or another solvent, a plant extract, a nicotine solution, and natural or artificial flavoring agents. Preferably, the liquid substrate further includes an aerosol-forming agent. Examples of a suitable aerosol-forming agent are glycerol and propylene glycol.

The seal member 12 is arranged between the transmission tube 11a and the upper support 13 and between the bottom base 16 and the upper housing 11, to seal a gap between the transmission tube 11a and the upper support 13 and a gap between the bottom base 16 and the upper housing 11. In another example, the seal member 12 may include a plurality of separate seal members. For example, one seal member is arranged between the transmission tube 11a and the upper support 13, and another seal member is arranged between the bottom base 16 and the upper housing 11. In another example, it is also feasible that the seal member 12 and the bottom base 16 (or the upper housing 11) are integrally formed, for example, integrally formed through double-shot molding. In another example, it is also feasible that the seal member 12 is not arranged.

In a further implementation, an air pressure balance channel may be arranged in the seal member 12, and/or between the seal member 12 and the transmission tube 11a, and/or between the seal member 12 and the upper housing 11, and/or between the transmission tube 11a and the upper support 13, and/or between the bottom base 16 and the upper housing 11, to supplement the liquid storage chamber A with a gas to balance air pressures within and outside the liquid storage chamber A, thereby facilitating transfer of the liquid substrate.

The upper support 13 is substantially in a shape of a tube. An upper end of the upper support 13 extends toward a first connection portion 161 and is connected to the transmission tube 11a. A lower end of the upper support 13 is accommodated in a second connection portion 162 of the bottom base 16. An inner hollow part of the upper support 13 defines the part of the airflow channel. An inner diameter or an outer diameter of a middle part of the upper support 13 is less than an inner diameter or an outer diameter of another part.

In a further implementation, a positioning portion 13b extending radially outward is arranged on an outer surface of the upper support 13 close to an upper end, and a groove 161c is provided in the first connection portion 161 of the bottom base 16. During assembly, the positioning portion 13b needs to be aligned with the groove 161c, so that the positioning portion 13b is at least partially fitted into the groove 161c, thereby fixing or holding the upper end of the upper support 13.

In a further implementation, a support portion 162b is arranged in the second connection portion 162 of the bottom base 16, and an end portion of the lower end of the upper support 13 abuts against the support portion 162b. In a preferred implementation, the support portion 162b includes a plurality of bumps arranged at intervals. The plurality of bumps extend longitudinally and protrude from an inner side wall or a bottom wall of the second connection portion 162. In this way, the liquid substrate spilling out of the atomization core 14 or the liquid substrate after the aerosol condenses in the airflow channel may flow into a collecting chamber 162c along a gap between the bumps. A groove formed between adjacent bumps extending longitudinally may hold a part of the liquid substrate.

In a further implementation, an accommodating groove 13c is provided on the outer surface of the upper support 13 close to the lower end. At least part of the seal member 15 is accommodated in the accommodating groove 13c. The seal member 15 is configured to seal a gap between the upper support 13 and the second connection portion 162.

In another example, it is also feasible that the upper support 13 and the transmission tube 11a are integrally formed.

The atomization core 14 is accommodated in the upper support 13 and is arranged close to the lower end of the upper support 13. After the assembly, the atomization core 14 is completely located in the second connection portion 162 of the bottom base 16. The atomization core 14 and the second connection portion 162 are coaxially arranged. A liquid passing hole 13a is provided on a side wall of the upper support 13. The liquid substrate stored in the liquid storage chamber A is transmitted to the atomization core 14 through the liquid passing hole 13a.

The atomization core 14 includes the susceptor 141. The susceptor 141 is configured to be inductively coupled to a magnetic field generator 26, and be penetrated by a variable magnetic field to generate heat, thereby heating the liquid substrate to generate an aerosol for inhalation. The susceptor 141 may be made of at least one of the following materials: aluminum, iron, nickel, copper, bronze, cobalt, ordinary carbon steel, stainless steel, ferritic stainless steel, martensitic stainless steel, or austenitic stainless steel.

In a further implementation, the atomization core 14 may further include a liquid transfer unit 142, to absorb the liquid substrate passing through the liquid passing hole 13a and transfer the absorbed liquid substrate to the susceptor 141. The liquid transfer unit 142 may surround the susceptor 141 to form an aerosol escape channel therein. The liquid transfer unit 142 has an ability to hold a liquid, and may have any suitable capillary and voidage for use in conjunction with different physical properties of the liquid substrate, for example, density, viscosity, surface tension, and vapor pressure. An example of a suitable material may be a ceramic or graphite-based material or a porous metal in the form of a fiber or a sintered powder, for example, porous ceramics, porous glass, a ceramic fiber, and a metal fiber. An example of a suitable material may be a natural fiber material or an artificial fiber material, for example, a natural cotton fiber, a glass fiber, a sponge, and a non-woven fabric. For example, the liquid transfer unit 142 is made of a fibrous material made of a spun fiber or an extruded fiber, for example, cellulose acetate, a polyester fiber, bonded polyolefin, a polyethylene fiber, a polypropylene fiber, and a nylon fiber. In some exemplary embodiments, a material of the liquid transfer unit 142 includes high density polyethylene (HDPE) or polyethylene glycol terephthalate (PET).

In some exemplary embodiments, the liquid transfer unit 142 may include a multilayer fiber mat. For example, the liquid transfer unit 142 is formed by stacking or winding at least two layers of fiber mats. The fiber mats include fiber bundles extending substantially in a direction. The fiber bundles on adjacent fiber mats extend in different directions.

In another implementation, the susceptor 141 may integrate functions of liquid guiding and atomization. It is also feasible that the liquid transfer unit 142 is not separately arranged, for example, an inductive heating material with a porous structure inside. The liquid transfer unit 142 may be in a shape of a bar or a tube or a rod, and may be further in a shape of a flat plate, or in a shape of a concave block having a concave chamber on a surface thereof, or in a shape of an arch of an arch structure, or the like.

In a preferred implementation, the liquid transfer unit 142 uses porous ceramics. A material of the porous ceramics includes at least one of alumina, zirconia, kaolin, diatomite, and montmorillonite. A porosity of the porous ceramics may be adjusted within a range of 10% to 90%, and an average pore size may be adjusted within a range of 10 μm to 150 μm. In some implementations, the adjustment may be performed, for example, by selecting an additive amount of a pore-forming agent and a particle size of the pore-forming agent.

In the preferred implementation, the liquid transfer unit 142 is in a shape of a hollow cylinder or a tube, and a shape of the susceptor 141 matches the shape of the liquid transfer unit 142. In the liquid transfer unit 142 in the shape of the hollow cylinder, an inner side wall thereof defines or forms an atomization surface of the atomization core 14, an outer side wall defines or forms a liquid absorption surface for absorbing the liquid substrate, and a hollow portion defines the part of the airflow channel. The atomized aerosol may flow to the air outlet of the electronic atomization device 100 together with air. The liquid transfer unit 142 in the shape of the hollow cylinder has an inner diameter ranging from 1 mm to 20 mm, an outer diameter ranging from 2 mm to 30 mm, and a height ranging from 0.5 mm to 50 mm. The susceptor 141 has an inner diameter ranging from 0.2 mm to 20 mm, a wall thickness ranging from 0.1 mm to 2 mm, and a height ranging from 0.5 mm to 50 mm. The susceptor 141 has a plurality of through holes 141 a arranged at intervals, with a pore size in a range of 0.1 mm to 0.5 mm, and the shape may be a circle, an ellipse, a triangle, a rhombus, or another regular or irregular shape. The aerosol may escape from the atomization surface into the airflow channel through the through holes 141a. In some examples, the through holes 141a may further increase a bonding force between the susceptor 141 and the porous ceramic after sintering, thereby increasing an overall strength of the atomization core 14.

The susceptor 141 may be arranged on an inner surface of the liquid transfer unit 142 or embedded in the liquid transfer unit 142. In some exemplary implementations, the susceptor 141 is constructed as a tube in a shape of a closed ring or a non-closed ring. The susceptor 141 is wound by a sheet metal mesh and supported on the inner surface of the liquid transfer unit 142. In some exemplary implementations, the susceptor 141 may further include a radial portion extending radially from an end of the tube. The radial portion may be attached to an end portion of the liquid transfer unit 142. In some exemplary implementations, the susceptor 141 is embedded in the liquid transfer unit 142, and co-fired with the liquid transfer unit 142 to form the atomization core 14. In this way, the liquid substrate does not need to be transmitted to the surface of the susceptor 141 for contact to begin atomization. Instead, the liquid substrate starts to be heated and atomized near a part close to the susceptor 141. On the one hand, the susceptor 141 is in thermally conductive contact with the liquid transfer unit 142, so that dry heating does not occur. On the other hand, most of the liquid substrates do not come into direct contact with the susceptor 141 during atomization, which can avoid metal contamination generated by the susceptor 141. In some exemplary implementations, the susceptor 141 may include a plurality of closed rings arranged at intervals. Each closed ring includes same or different metallic materials, for example, Curie temperatures of materials of different closed ring are different.

The bottom base 16 and the upper housing 11 constitute a housing assembly of the atomizer 10. The bottom base 16 includes a first connection portion 161 and a second connection portion 162 that are integrally formed. In another example, it is also feasible that the first connection portion 161 and the second connection portion 162 are separately formed.

The first connection portion 161 is accommodated in the upper housing 11. A cross section of the first connection portion 161 is substantially in a shape of an ellipse. An area of an upper open end of the first connection portion 161 is greater than an area of a lower open end thereof, and the lower open end is adjacent to the second connection portion 162 or defines an upper open end of the second connection portion 162. In the first connection portion 161, the upper open end and the lower open end are connected by at least one inclined surface 161d, so that an interior thereof is funnel-shaped. Then when a relatively small quantity of liquid substrates exist in the liquid storage chamber, the liquid substrates can flow to the second connection portion 162 without accumulating in the first connection portion 161, thereby increasing a utilization rate of the liquid substrate.

In a preferred implementation, a bump (not shown) is arranged on an outer surface of the first connection portion 161, and a groove (not shown) is provided on an inner surface of the upper housing 11. A snap fit of the first connection portion 161 and the upper housing 11 is implemented through engagement of the bump and the groove.

In a preferred implementation, a lower end of the first connection portion 161 has a support portion 161a extending radially outward to support an end portion of an open end of the upper housing 11. A step is further arranged on the outer surface of the first connection portion 161 close to the upper end. A part of the seal member 12 is held on the step.

The second connection portion 162 is exposed from the upper housing 11 or the atomizer 10. In this way, the upper housing 11 constitutes a first part of the housing assembly of the atomizer 10, and the second connection portion 162 constitutes a second part of the housing assembly of the atomizer 10.

The second connection portion 162 is constructed in a shape of a sleeve, and has a radial size less than or equal to 9 mm. The radial size of the second connection portion 162 is less than a radial size of the first connection portion 161. For example, a size of a cross section of the second connection portion 162 in a width direction is less than a size of the first connection portion 161 in the width direction, a size of the cross section of the second connection portion 162 in a length direction is less than a size of the first connection portion 161 in a length direction, a size of an outer diameter of the cross section of the second connection portion 162 is less than a size of an outer diameter of the first connection portion 161, or a cross-sectional area of the first connection portion 161 is greater than a cross-sectional area of the second connection portion 162, and a length dimension of the second connection portion 162 extending along a longitudinal direction is greater than a length dimension of the first connection portion 161.

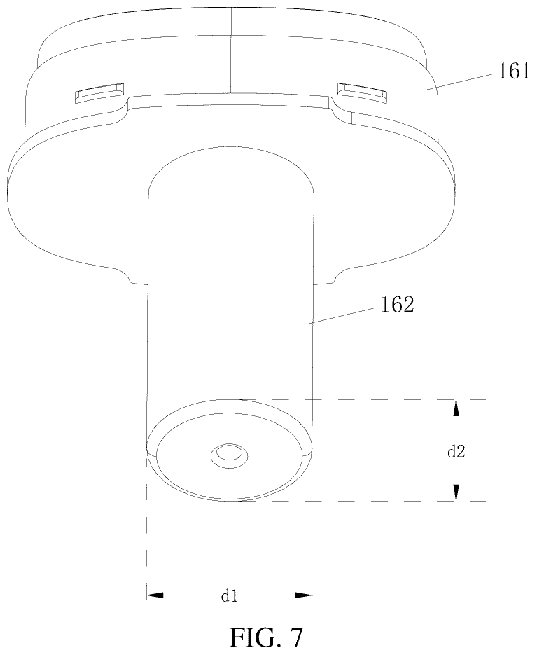

In a preferred implementation, as shown in FIG. 7, the cross section of the second connection portion 162 is in the shape of an ellipse, and the radial size of the second connection portion 162 is a size of a major axis or a minor axis of the ellipse. A difference between the major axis and the minor axis of the second connection portion 162 is in a range of 0.5 mm to 2 mm (preferably, in a range of 0.5 mm to 1.5 mm; and further preferably, in a range of 0.5 mm to 1 mm). Specifically, a length of a major axis d1 of the ellipse is in a range of 8 mm to 9 mm (preferably, in a range of 8 mm to 8.8 mm; further preferably, in a range of 8 mm to 8.6 mm; further preferably, in a range of 8.2 mm to 8.6 mm; and further preferably, in a range of 8.4 mm to 8.6 mm). A length of a minor axis d2 of the ellipse is in a range of 6 mm to 8 mm (preferably, in a range of 7 mm to 8 mm; and further preferably, in a range of 7.2 mm to 8 mm; and further preferably, in a range of 7.4 mm to 8 mm; and further preferably, in a range of 7.6 mm to 8 mm; and further preferably, in a range of 7.6 mm to 7.8 mm). In a specific embodiment, the length of the major axis dl is 8.5 mm, and the length of the minor axis d2 is 7.7 mm.

In another example, the cross section of the second connection portion 162 may also be in the shape of a circle. The radial size of the second connection portion 162 is a diameter of the circle.

An air inlet 162a is provided on a bottom end of the second connection portion 162. A wall on which the air inlet 162a is formed protrudes from the bottom end of the second connection portion 162, to prevent the liquid substrate collected in the collecting chamber 162c from directly flowing to the power supply assembly 20 through the air inlet 162a. External air flows in through the air inlet 162a, successively passes through the liquid transfer unit 142 in the shape of the hollow cylinder (and/or the susceptor 141), the upper support 13, and the transmission tube 11a, and flows out of the air outlet of the upper housing 11.

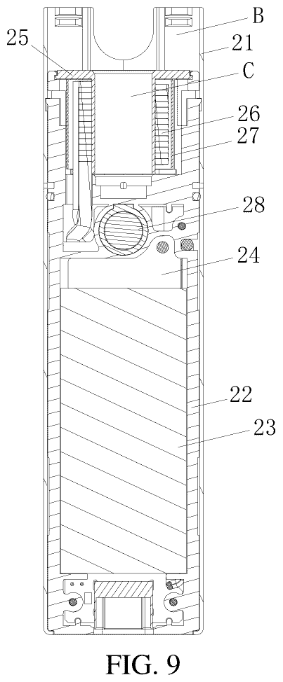

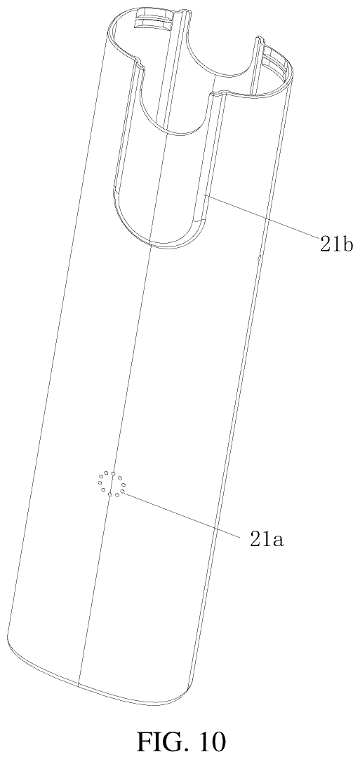

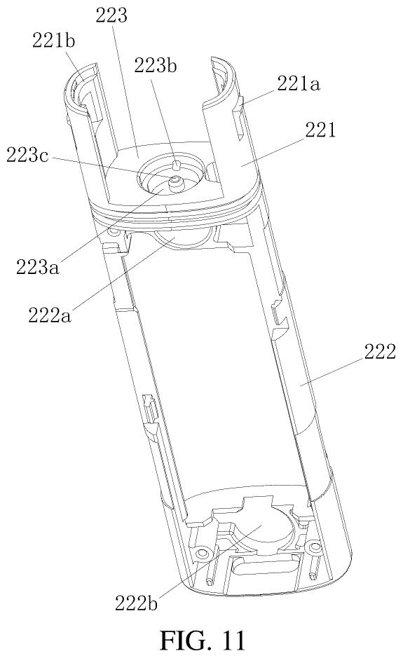

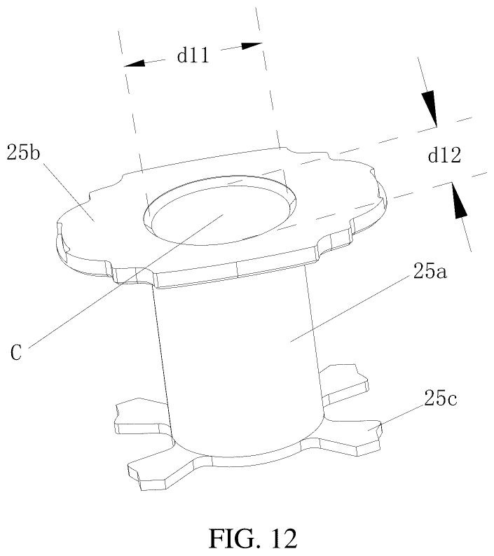

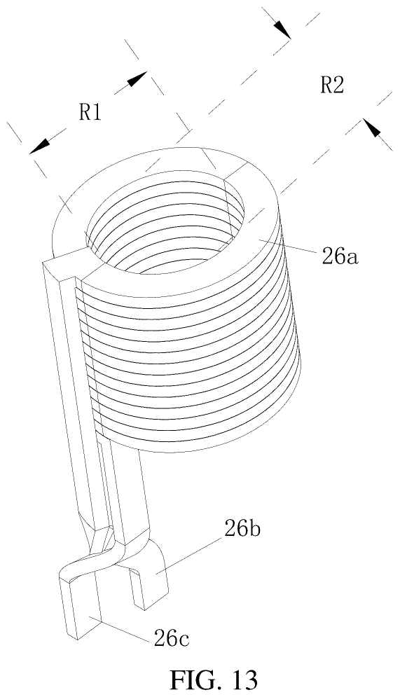

As shown in FIG. 9 to FIG. 14, the power supply assembly 20 includes a lower housing 21, a lower support 22, a battery core 23, a circuit 24, a base 25, a magnetic field generator 26, a shielding member 27, and a sensor 28.

The lower housing 21 is a cylindrical structure having two open ends. The lower housing 21 and the upper housing 11 define a housing of an electronic atomization device 100.

An airflow inlet 21a is provided on an outer surface of the lower housing 21. External air may flow into the lower housing 21 through the airflow inlet 21a. A part of an outer surface of front and rear sides of the lower housing 21 protrudes to form a protruding portion 21b (or a part of an inner surface of the front and rear sides of the lower housing 21 is recessed to form the protruding portion 21b on the outer surface of the lower housing 21). Through the protruding portion 21b, a size of a part of the electronic atomization device 100 in a thickness direction may be increased, and then a magnetic field generator 26 with a larger size may be accommodated, for example, an induction coil.

The lower support 22 includes an accommodating portion 221 and a mounting portion 222. The accommodating portion 221 and the mounting portion 222 are separated by a separating plate 223.

The lower support 22 is accommodated in the lower housing 21. A size of the lower support 22 in a length direction is less than a size of the lower housing 21 in a length direction. A receiving portion B is formed between an upper end of the lower support 22 and an upper end of the lower housing 21 or between the lower support 22 and an inner surface of the lower housing 21, and a lower end of the lower support 22 abuts against an end portion of a lower end of the lower housing 21. After assembly, a part of the upper housing 11 is received in the receiving portion B.

A cantilever 221a is arranged on an outer surface of the accommodating portion 221. The cantilever 221a is snap-fitted to a groove on the inner surface of the lower housing 21. A step 221b is arranged on an inner surface of the accommodating portion 221. A body portion 25a of the base 25 is accommodated in the accommodating portion 221. An extension 25b of the base 25 abuts against the step 221b, and a plurality of extensions 25c of the base 25 abut against the separating plate 223.

A component may be mounted to the front and rear of the mounting portion 222. In the example, the battery core 23 is mounted to the front of the mounting portion 222, and the circuit 24 is mounted to the rear of the mounting portion 222. To be specific, the components are successively arranged along a thickness direction of the electronic atomization device 100. An accommodating chamber 222a and an accommodating chamber 222b are further arranged in the mounting portion 222. The accommodating chamber 222a is configured to accommodate the sensor 28. The accommodating chamber 222b is configured to accommodate a motor (not shown). The motor generates a prompt signal to prompt a user. Specific prompt information is not limited herein.

A groove 223a is provided on the separating plate 223. The groove 223a is coaxial with a receiving portion C. An airflow inlet 223b is provided in the groove 223a. Air may flow into the groove 223a through the airflow inlet 223b, and then flow into an atomizer 10 through the air inlet 162a of a bottom base 16. An induction channel 223c is further arranged in the groove 223a. The induction channel 223c is in communication with the accommodating chamber 222a.

The battery core 23 is configured to provide electric power for operating the electronic atomization device 100. The battery core 23 may be a rechargeable battery core or a disposable battery core.

The circuit 24 may control overall operations of the electronic atomization device 100. The circuit 24 not only controls operations of the battery core 23 and the magnetic field generator 26, but also controls an operation of another element in the electronic atomization device 100. The circuit 24 includes at least one processor. The processor may include a logic gate array, or may include a combination of a general-purpose microprocessor and a memory that stores programs executable in the microprocessor. In addition, a person skilled in the art should understand that the circuit 24 may include another type of hardware.

The base 25 includes the body portion 25a, and an internal hollow portion thereof defines or forms at least part of the receiving portion C. The extension 25b is arranged on an upper end of the body portion 25a, and a plurality of extensions 25c are arranged on the lower end. After assembly, at least part of the second connection portion 162 of the bottom base 16 is received in the receiving portion C. A radial size of the receiving portion C is in a range of 7 mm to 20 mm. In a preferred implementation, a cross section of the body portion 25a is in the shape of an ellipse. That is, the receiving portion C is in the shape of an ellipse. The radial size of the receiving portion C is a size of a major axis or a minor axis of the ellipse. A difference between the major axis and the minor axis of the receiving portion C is in a range of 0.5 mm to 2 mm (preferably, in a range of 0.5 mm to 1.5 mm; and further preferably, in a range of 0.5 mm to 1 mm). The receiving portion C is in the shape of an ellipse, which is beneficial to the overall flat shape of the electronic atomization device 100, thereby improving aesthetics of the electronic atomization device 100. Specifically, a length of a major axis d11 of the ellipse is in a range of 7 mm to 10 mm (preferably, in a range of 7 mm to 9 mm; further preferably, in a range of 7.5 mm to 9 mm; further preferably, in a range of 8 mm to 9 mm; and further preferably, in a range of 8.5 mm to 9 mm). A length of a minor axis d12 of the ellipse is in a range of 7 mm to 9 mm (preferably, in a range of 7 mm to 8.5 mm; further preferably, in a range of 7 mm to 8.3 mm; further preferably, in a range of 7 mm to 8.1 mm; further preferably, in a range of 7.5 mm to 8.1 mm; further preferably, in a range of 7.7 mm to 8.1 mm; and further preferably, in a range of 7.9 mm to 8.1 mm). In a specific embodiment, the length of the major axis d11 is 8.8 mm, and the length of the minor axis d12 is 8 mm.

The magnetic field generator 26 is configured to generate a variable magnetic field under an alternating current. The magnetic field generator 26 includes, but is not limited to, an induction coil. The magnetic field generator 26 is arranged close to the receiving portion C. The magnetic field generator 26 at least partially surrounds the receiving portion C. The body portion 26a of the magnetic field generator 26 is sleeved outside the body portion 25a of the base 25. An electrical connection portion 26b and an electrical connection portion 26c of the magnetic field generator 26 are configured to be electrically connected to the battery core 23. When the second connection portion 162 of the bottom base 16 is at least partially received in the receiving portion C, the atomization core 14 or the susceptor 141 is completely located in the receiving portion C, so that a magnetic field generated by the magnetic field generator 26 can substantially cover the susceptor 141. In this way, a coupling distance between the susceptor 141 and the magnetic field generator 26 is reduced, thereby improving heating efficiency of the atomizer 10. In a preferred implementation, when the second connection portion 162 of the bottom base 16 is at least partially received in the receiving portion C, the susceptor 141 and the magnetic field generator 26 are coaxial and both extend along an axial direction of the electronic atomization device 100, which is beneficial to improve the heating efficiency of the atomizer 10. An extension length of the magnetic field generator 26 along the axial direction is greater than an extension length of the susceptor 141 along the axial direction.

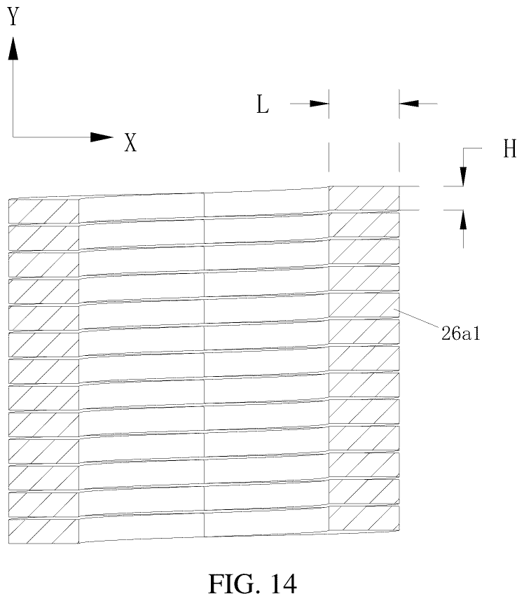

As shown in FIG. 13 and FIG. 14, the body portion 26a of the magnetic field generator 26 is a solenoid coil wound by a relatively long wire material. For example, it is formed by coiling 1600-1900 Litz wires of a size of 0.02 mm, or it may be formed by coiling 750-1050 Litz wires of a size of 0.03 mm. A number of turns or windings of the solenoid coil is in a range of 6 to 20; preferably, in a range of 6 to 15; further preferably, in a range of 6 to 12; and further preferably, in a range of 6 to 10. A spacing between adjacent windings is approximately in a range of 0.1-0.5 mm. In a specific embodiment, the spacing between adjacent windings is 0.2 mm or 0.4 mm. The spacing between adjacent windings may be the same or different.

A cross section of a wire material has a first side extending along a radial direction X of the magnetic field generator 26 and a second side extending along an axial direction Y of the magnetic field generator 26. The cross section of the wire material is substantially in a shape of a rectangle. A size L of the first side is greater than a size H of the second side, so that the wire material of the magnetic field generator 26 has a flat structure, which is beneficial to increase the number of turns of the magnetic field generator 26 per unit length and then increase an inductance value. In addition, the second side is arranged against a wall of the receiving portion C, that is, arranged against the outer surface of the body portion 25a of the base 25. Alternatively, the number of turns of the magnetic field generator 26 may be increased within a limited height space.

In a preferred implementation, a ratio of the size L of the first side to the size H of the second side is in a range of 1.5-3; preferably, in a range of 2 to 3; and further preferably, in a range of 2.5 to 3. For example, in a specific embodiment, the ratio of the size L of the first side to the size H of the second side is 2.8.

In a preferred implementation, the size L of the first side is approximately in a range of 1-5 mm, and the size H of the second side is approximately in a range of 0.3-1 mm. For example, in a specific embodiment, the size L of the first side is 2.5 mm, and the size H of the second side is 0.9 mm.

In a preferred implementation, a total length of the body portion 26a of the magnetic field generator 26 along the axial direction Y is approximately in a range of 5-20 mm. In a specific embodiment, a total length of the body portion 26a of the magnetic field generator 26 along the axial direction Y is 12.2 mm.

In a preferred implementation, a cross section of a hollow portion of the body portion 26a is non-circular, for example, in the shape of an ellipse, an ovoid, or a racetrack. In some examples, a difference between the major axis and the minor axis of the ellipse is in a range of 0.5 mm to 2 mm. Specifically, a length of a major axis R1 of the ellipse is in a range of 8 mm to 15 mm (preferably, in a range of 8 mm to 12 mm; further preferably, in a range of 8 mm to 10 mm; and further preferably, in a range of 9 mm to 10 mm). A length of a minor axis R2 of the ellipse is in a range of 8 mm to 13 mm (preferably, in a range of 8 mm to 11 mm; further preferably, in a range of 8 mm to 10 mm; and further preferably, in a range of 8 mm to 9 mm). In a specific embodiment, the length of the major axis R1 of the ellipse is 9.7 mm, and the length of the minor axis R2 of the ellipse is 8.9 mm.

The shielding member 27 is arranged around or sleeved outside the body portion 26a of the magnetic field generator 26. The shielding member 27 is configured to shield the magnetic field emitted from the magnetic field generator 26 substantially along the radial direction, to prevent the emitted magnetic field from affecting another component.

The sensor 28 is configured to sense a change in airflow in the groove 223a through the induction channel 223c, that is, detect inhalation of the user, to generate a signal to control the atomizer 10 to start operating.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are provided for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications based on the above descriptions, and all of the improvements and modifications shall fall within the protection scope of the appended claims of this application.

1. An atomizer comprising:
a housing assembly, wherein a liquid storage chamber for storing a liquid substrate is arranged in the housing assembly;
the housing assembly comprising a first part and a second part which are longitudinally arranged, wherein an air outlet is formed on an end of the first part, at least part of the liquid storage chamber is defined by the first part, the second part longitudinally extends from an end of the first part away from the air outlet, and a radial size of the second part is reduced relative to that of the first part;
a susceptor, accommodated in the second part and configured to be penetrated by a variable magnetic field to generate heat, so as to heat the liquid substrate from the liquid storage chamber to generate an aerosol; and
an airflow channel, configured to guide the aerosol to the air outlet.

2. The atomizer according to claim 1, wherein the second part is constructed in a shape of a sleeve, and a radial size of the sleeve is less than or equal to 9 mm.

3. The atomizer according to claim 1, wherein a cross section of the second part is in a shape of a circle; or a cross section of the second part is substantially in a shape of an ellipse, and a difference between a major axis and a minor axis of the ellipse is in a range of 0.5 mm to 2 mm.

4. The atomizer according to claim 1, wherein a part of the liquid storage chamber extends into the second part and surrounds the susceptor.

5. The atomizer according to claim 1, further comprising a liquid transfer unit accommodated in the second part, wherein the susceptor contacts a surface of the liquid transfer unit or is embedded in the liquid transfer unit.

6. The atomizer according to claim 1, wherein the susceptor is constructed as a tube in a shape of a closed ring or a non-closed ring.

7. The atomizer according to claim 1, wherein the susceptor is arranged substantially coaxially with the second part.

8. The atomizer according to claim 1, wherein the housing assembly comprises an upper housing and a bottom base, the bottom base comprises a first connection portion mounted to the upper housing and a second connection portion exposed from the upper housing, and the second connection portion constitutes at least part of the second part.

9. The atomizer according to claim 8, wherein the first connection portion has an upper open end and a lower open end opposite to the upper open end, and an opening area of the upper open end is greater than an opening area of the lower open end.

10. The atomizer according to claim 8, wherein the first connection portion has an upper open end and a lower open end opposite to the upper open end, and the upper open end is connected to the lower open end through at least one inclined surface.

11. The atomizer according to claim 8, wherein an area of a cross section of the first connection portion is greater than an area of a cross section of the second connection portion.

12. The atomizer according to claim 8, wherein a size of the second connection portion in a longitudinal direction is greater than a size of the first connection portion in the longitudinal direction.

13. The atomizer according to claim 1, wherein an air inlet in communication with the airflow channel is provided on a bottom end of the second part.

14. The atomizer according to claim 1, further comprising an upper support, wherein an end of the upper support is accommodated in the second part, and another end extends toward the first part, and the susceptor is accommodated in the support and is arranged close to an end of the upper support.

15. An electronic atomization device comprising the atomizer according to claim 1 and a power supply assembly detachably connected to the atomizer, wherein the power supply assembly comprises:
a first receiving portion configured to receive at least part of the second part; and
a magnetic field generator configured to generate a variable magnetic field under an alternating current,
wherein the magnetic field generator is arranged close to the first receiving portion.

16. The electronic atomization device according to claim 15, wherein the power supply assembly further comprises a shielding member configured to shield a part of the magnetic field, and the shielding member surrounds outside of the magnetic field generator.

17. The electronic atomization device according to claim 15, wherein the power supply assembly further comprises a base, a hollow part inside the base defines at least part of the first receiving portion, and the magnetic field generator is sleeved on a periphery of the base.

18. (canceled)

19. The electronic atomization device according to claim 15, wherein the magnetic field generator comprises a coil, and a cross section of a wire material of the coil is constructed to be flat with different aspect ratios.

20. The electronic atomization device according to claim 15, wherein the power supply assembly further comprises a lower housing and a lower support, and the lower support is arranged in the lower housing; and
the lower support and an inner surface of the lower housing define a second receiving portion, to receive a part of a first part of the atomizer.

21. The electronic atomization device according to claim 20, wherein the inner surface of the lower housing is partially recessed to form a protruding portion on an outer surface of the lower housing.
